(19) United States
(12) Patent Application Publication
(10) Pub. No.: US 2026/0200075 A1
(43) Pub. Date: Jul. 16, 2026

(54) SYSTEM FOR SECURING A PAYLOAD TO AN AUTONOMOUS MOBILE ROBOT (AMR)

(71) Applicant: GM GLOBAL TECHNOLOGY OPERATIONS LLC, Detroit, MI (US)

(72) Inventors: Jesse HEIDRICH, Shelby Township, MI (US); Jeffrey Paul MULNIX, Linden, MI (US); Joel S. HOOTON, Chesterfield, MI (US); Joshua Lee SOLOMON, Berkley, MI (US)

(21) Appl. No.: 19/022,149

(22) Filed: Jan. 15, 2025

(51) Int. Cl. B25J 9/00; B25J 5/00; B25J 19/06

(52) U.S. Cl. CPC B25J 9/0021; B25J 5/007; B25J 19/06

(57) ABSTRACT

An autonomous mobile robot (AMR includes a body, a propulsion system mounted to the body, a motor operatively connected to the propulsion system, a power supply supported by the body and operatively connected to the motor, and a controller operatively connected to the power supply, the propulsion system, and the motor. The controller is configured to control the propulsion system to move the body from one location to another. A payload support member is mounted to the body. The payload support member includes a payload support surface and a selectively activatable payload connector operatively connected to the controller. The controller is configured and disposed to selectively activate the selectively activatable payload connector to engage a payload resting on the payload support surface of the payload support member.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to the art of autonomous mobile robots (AMRs) and, more particularly, to a system for securing payloads to an AMR.

Autonomous mobile robots (AMR) are used in a wide array of industries to autonomously transport articles from one place to another. Hospitals employ AMRs to move filed between locations. Factories employ AMRs to move parts between workstations and a storage area. Warehouses employ AMRs to transport goods from storage areas to staging areas in order to fulfil orders.

When used to transport goods from one location to another, particularly, larger goods that would not fit in basket, human intervention is required. That is, a human is needed to secure the goods to the AMRs during transport. Even if a load may be placed on the AMR without human intervention, a human is still needed to secure that good to the AMR prior to transport. If not properly secured, the good may become dislodged from the AMR and become damaged during transport.

### SUMMARY

An autonomous mobile robot (AMR), in accordance with the present disclosure, includes a body, a propulsion system mounted to the body, a motor operatively connected to the propulsion system, a power supply supported by the body and operatively connected to the motor, and a controller operatively connected to the power supply, the propulsion system, and the motor. The controller is configured to control the propulsion system to move the body from one location to another. A payload support member is mounted to the body. The payload support member includes a payload support surface and a selectively activatable payload connector operatively connected to the controller. The controller is configured and disposed to selectively activate the selectively activatable payload connector to engage a payload resting on the payload support surface of the payload support member.

In other features, the selectively activatable payload connector comprises a selectively deployable shaft that is extended upwardly into engagement with the payload.

In other features, a motor is operatively connected to the selectively activatable payload connector, the motor being operable to shift the selectively deployable shaft upwardly.

In other features, the motor comprises a linear actuator.

In other features, the payload support member includes a payload connector receiver and a guide member extending through the payload connector receiver, the selectively deployable shaft being axially shiftable along the guide member.

In other features, the selectively deployable shaft includes a shaft axis and a plurality of internal threads extending along the shaft axis.

In other features, the selectively deployable shaft rotates about the shaft axis when shifted upwardly.

In other features, the selectively deployable shaft is formed from a pliable material.

In other features, the body includes a lower surface including a plurality of selectively deployable shaft receivers configured to connect with another AMR.

In other features, the selectively activatable payload connector comprises an electromagnet.

A method of securing a payload to an autonomous mobile robot (AMR), in accordance with the present disclosure, includes positioning the payload on a payload support surface of a payload support member mounted to the AMR, activating one or more selectively activatable payload connectors provided in the payload support member, and joining the payload to the payload support surface with the one or more selectively activated payload connectors.

In other features, activating the one or more selectively activatable payload connectors includes extending a selectively deployable shaft outwardly from the payload support surface.

In other features, extending the selectively deployable shaft outwardly from the payload support surface includes activating an electric motor arranged in the AMR and operatively connected to the selectively deployable shaft.

In other features, activating the electric motor includes activating a solenoid to extend the selectively deployable shaft.

In other features, extending the selectively deployable shaft includes shifting the selectively deployable shaft along a guide member connected to the payload support member and disposed in payload connector receiver.

In other features, shifting the selectively deployable shaft along the guide member includes imparting a rotation to the selectively deployable shaft.

In other features, joining the payload to the payload support surface includes engaging a plurality of external threads on the selectively deployable shaft with a plurality of external threads on the payload connector receiver.

In other features, misalignments between the AMR and the payload are accommodated by flexing the selectively deployable shaft when joining the payload.

In other features, positioning the payload on the payload support surface includes placing another AMR on the payload support surface.

In other features, activating the one or more selectively activatable payload connectors provided in the payload support member includes activating one or more electromagnets provided in the payload support surface.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side view of an autonomous mobile robot (AMR) including a system for securing payloads, in accordance with the present disclosure;

FIG. 2A is a perspective view of a payload support member of the AMR of FIG. 1 with a plurality of selectively activatable payload connectors arranged in a first configuration, in accordance with the present disclosure;

FIG. 2B is a perspective view of a payload support member of the AMR of FIG. 1 with a plurality of selectively activatable payload connectors arranged in a second configuration, in accordance with the present disclosure;

FIG. 2C is a perspective view of a payload support member of the AMR of FIG. 1 with a plurality of selectively activatable payload connectors arranged in a third configuration, in accordance with the present disclosure;

FIG. 2D is a perspective view of a payload support member of the AMR of FIG. 1 with a plurality of selectively activatable payload connectors arranged in a fourth configuration, in accordance with the present disclosure;

FIG. 3 is a cross-sectional view of a selectively activatable payload connector taken through the line 3-3 in FIG. 2A, in accordance with the present disclosure;

FIG. 4 is a side view of the AMR of FIG. 1 illustrating selectively activatable payload connectors, in accordance with an aspect of the present disclosure;

FIG. 5 is a side view of multiple connected AMRs, in accordance with the present disclosure;

FIG. 6 is a block diagram depicting a controller of the AMR of FIG. 1, in accordance with the present disclosure; and

FIG. 7 is a side view of an AMR including a system for securing payloads, in accordance with another aspect of the present disclosure.

In the drawings, reference numbers may be reused to identify similar and/or identical elements.

### DETAILED DESCRIPTION

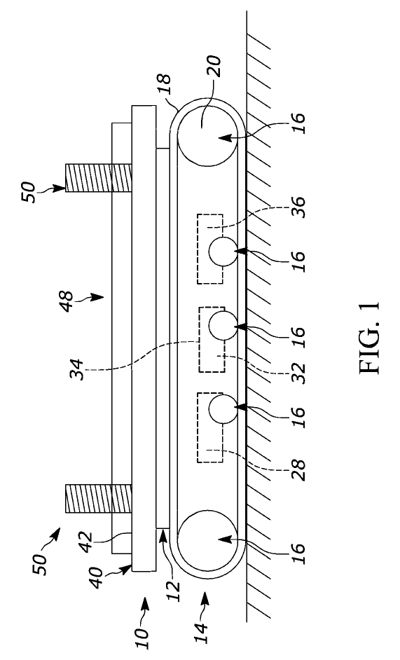

An autonomous mobile robot (AMR), in accordance with the present disclosure, is indicated generally at 10 in FIG. 1. AMR 10 includes a body 12 having a propulsion system 14. Propulsion system 14 includes a plurality of wheels 16 and a track 18 that extends about the plurality of wheels 16. One of the plurality of wheels 16 is a drive wheel 20 that motivates track 18. Drive wheel 20 is operatively connected to a motor 28. Motor 28 is connected to a power supply 32 in body 12. Power supply 32 takes the form of a rechargeable battery 34. AMR 10 also includes a controller 36 arranged in body 12. Controller 36 is operatively connected to motor 28 and power supply 32.

AMR 10 includes a payload support member 40 arranged on body 12. Payload support member 40 includes a payload support surface 42. A payload 48 is positioned on payload support surface 42. As will be detailed more fully herein, payload 48 is secured to payload support surface 42 without the need for human intervention. That is, AMR 10 includes a plurality of selectively activatable payload connectors 50 operatively connected to controller 36. Selectively activatable payload connectors deploy from payload support surface 42 and autonomously engage with load 48. Selectively activatable payload connectors 50 can be distributed about payload support surface 42 in a wide array of geometries.

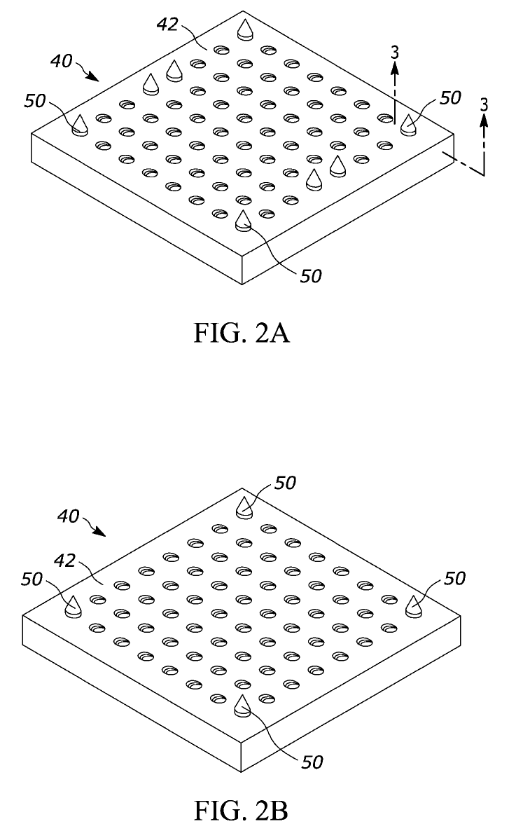

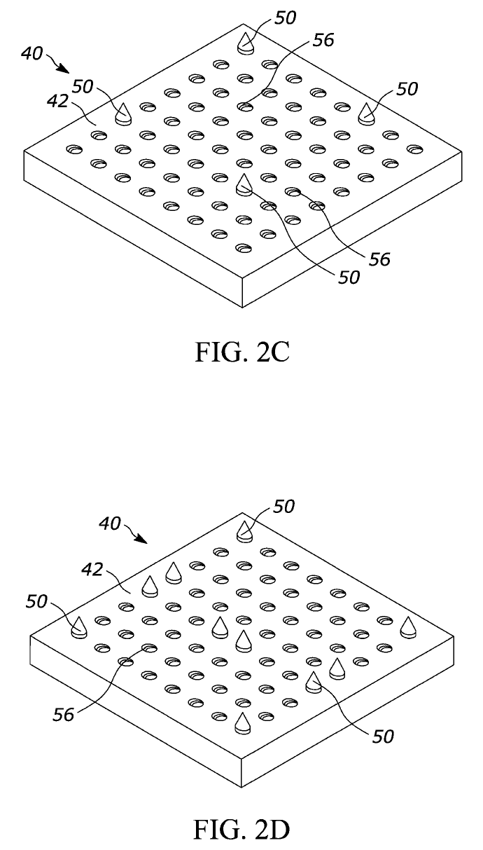

As shown in in FIG. 2A, selectively activatable payload connectors 50 may be arranged about forward and rear edges (not separately labeled) of payload support surface 42. In FIG. 2B, selectively activatable payload connectors 50 are arranged at corners (also not separately labeled) of payload support surface 42. FIG. 2C depicts selectively activatable payload connectors 50 arranged in a quadrilateral formation, and in FIG. 2D, selectively activatable payload connectors 50 are arranged at forward and rear edges and also centrally on payload support surface 42. The particular arrangement of selectively activatable payload connectors 50 may vary depending upon the type, geometry, and structure of payload 48.

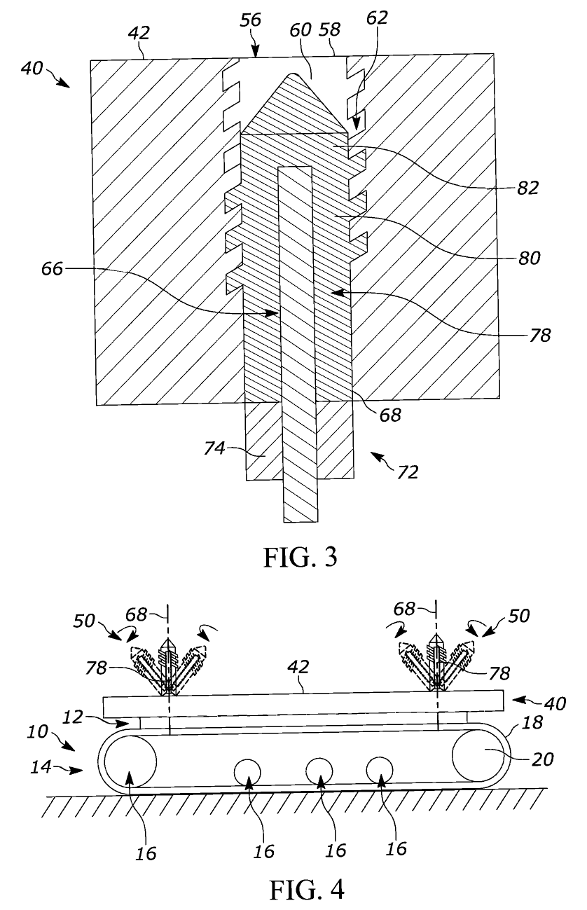

Reference will now follow to FIG. 3 in describing one of the selectively activatable payload connectors 50 with an understanding that others of the selectively activatable payload connectors 50 may be similarly formed. Each selectively activatable payload connector 50 is arranged in payload connector receiver 56 shown as a cylindrical bore 58 formed in payload support member 40. Cylindrical bore 58 includes an inner surface 60 having a plurality of threads 62 which, as will be detailed more fully herein, impart a rotational motion to selectively activatable payload connector 50 during deployment.

In accordance with the present disclosure, selectively activatable payload connector 50 includes a selectively deployable shaft 66 having a shaft axis 68 that extends perpendicularly relative to payload support surface 42. Selectively deployable shaft 66 connected to a connector motor 72 that may take the form of a solenoid 74 or linear actuator. Selectively deployable shaft 66 includes a shaft body 78 having a plurality of external threads 80 that engage with plurality of threads 62 formed on inner surface 60 of cylindrical bore 58. With this construction, while being deployed or retracted, plurality of external threads 80 on shaft body 78 interact with plurality of threads 62 on inner surface of cylindrical bore 58 to impart a rotation force to selectively activatable payload connector 50 while moving along shaft axis 68. The rotational force causes shaft body 78 to engage with a connector receiver (not shown) on payload 48.

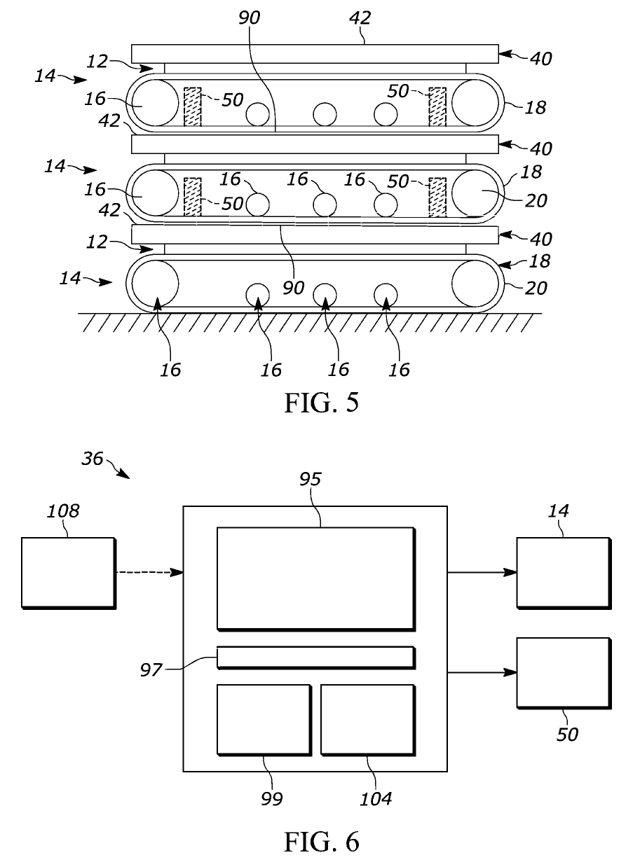

In accordance with an aspect of the present disclosure, shaft body 78 may be formed from a flexible material 82 such as shown in FIG. 4. Flexible material 82 allows shaft body 78 to bend or deflect about shaft axis 68 to accommodate any misalignments between selectively activatable payload connector 50 and payload 48. Additionally, as shown in FIG. 5, body 12 includes a lower surface 90 that includes connector receivers (not separately labeled) that allow multiple AMRs to be stacked on, atop another, and be secured during transport.

Reference will now follow to FIG. 6 in describing controller 36 in accordance with an aspect of the present disclosure. Controller 36 includes a central processing unit (CPU) 95 operatively connected to a non-volatile member 97, a drive control module 99 and a payload control module 104. Non-volatile memory 97 may include a set(s) of stored code and or instructions that provides navigation instructions that are used by drive control module 99 to autonomously move AMR 10 between selected locations. Non-volatile memory 97 may also store code that represents one or more sets of payload configuration data that instruct payload control module 104 which one(s) and in what geometry selectively activatable payload connectors 50 should be deployed in order to connect with payload 48. Controller 36 may also receive instructions through a wireless interface 108 that communicates with drive control module 99 and/or payload module 104.

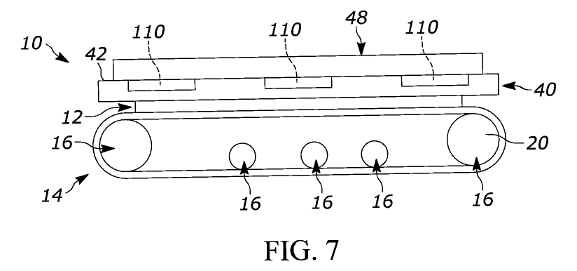

At this point, it should be understood that while selectively activatable payload connectors 50 are shown and described as selectively deployable shafts 66, other configurations are also contemplated. For example, as shown in FIG. 7, selectively activatable payload connector 50 may take the form of one or more electromagnets 110 deployed about payload support surface 42. Electromagnet(s) 110 are connected to controller 36 and may be used to secure payloads formed from, or including portions having, a ferro-magnetic material such as iron, nickel, cobalt, and many forms of steel. Further while described as rotating into engagement with a load, other engagement mechanisms are also contemplated.

At this point, it should be clear, that selectively activatable payload connector(s) 50 may be activated without human intervention to secure a payload to an AMR. By eliminating the need for human intervention, the AMR may be even more autonomous. The AMR may be loaded, transport, and drop off payloads without the need for operator intervention.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including "connected," "engaged," "coupled," "adjacent," "next to," "on top of," "above," "below," and "disposed." Unless explicitly described as being "direct," when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean "at least one of A, at least one of B, and at least one of C."

In this application, including the definitions below, the term "module" or the term "controller" may be replaced with the term "circuit." The term "module" may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on- chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be onsidered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operation systems, user application background services, background application etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java@, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An autonomous mobile robot (AMR) comprising:
a body;
a propulsion system mounted to the body;
a motor operatively connected to the propulsion system;
a power supply supported by the body and operatively connected to the motor;
a controller operatively connected to the power supply, the propulsion system, and the motor, the controller being configured to control the propulsion system to move the body from one location to another; and
a payload support member mounted to the body, the payload support member including a payload support surface and a selectively activatable payload connector operatively connected to the controller, wherein the controller is configured and disposed to selectively activate the selectively activatable payload connector to engage a payload resting on the payload support surface of the payload support member.

2. The AMR according to claim 1, wherein the selectively activatable payload connector comprises a selectively deployable shaft that is extended upwardly into engagement with the payload.

3. The AMR according to claim 2, further comprising a motor operatively connected to the selectively activatable payload connector, the motor being operable to shift the selectively deployable shaft upwardly.

4. The AMR according to claim 3, wherein the motor comprises a linear actuator.

5. The AMR according to claim 3, wherein the payload support member includes a payload connector receiver and a guide member extending through the payload connector receiver, the selectively deployable shaft being axially shiftable along the guide member.

6. The AMR according to claim 5, wherein the selectively deployable shaft includes a shaft axis and a plurality of internal threads extending along the shaft axis.

7. The AMR according to claim 6, wherein the selectively deployable shaft rotates about the shaft axis when shifted upwardly.

8. The AMR according to claim 3, wherein the selectively deployable shaft is formed from a pliable material.

9. The AMR according to claim 3, wherein the body includes a lower surface including a plurality of selectively deployable shaft receivers configured to connect with another AMR.

10. The AMR according to claim 1, wherein the selectively activatable payload connector comprises an electromagnet.

11. A method of securing a payload to an autonomous mobile robot (AMR), the method comprising:
positioning the payload on a payload support surface of a payload support member mounted to the AMR;
activating one or more selectively activatable payload connectors provided in the payload support member; and
joining the payload to the payload support surface with the one or more selectively activated payload connectors.

12. The method of claim 11, wherein activating the one or more selectively activatable payload connectors includes extending a selectively deployable shaft outwardly from the payload support surface.

13. The method of claim 12, wherein extending the selectively deployable shaft outwardly from the payload support surface includes activating an electric motor arranged in the AMR and operatively connected to the selectively deployable shaft.

14. The method of claim 13, wherein activating the electric motor includes activating a solenoid to extend the selectively deployable shaft.

15. The method of claim 12, wherein extending the selectively deployable shaft includes shifting the selectively deployable shaft along a guide member connected to the payload support member and disposed in payload connector receiver.

16. The method of claim 15, wherein shifting the selectively deployable shaft along the guide member includes imparting a rotation to the selectively deployable shaft.

17. The method of claim 16, wherein joining the payload to the payload support surface includes engaging a plurality of external threads on the selectively deployable shaft with a plurality of external threads on the payload connector receiver.

18. The method of claim 13, further comprising accommodating misalignments between the AMR and the payload by flexing the selectively deployable shaft when joining the payload.

19. The method of claim 11, wherein positioning the payload on the payload support surface includes placing another AMR on the payload support surface.

20. The method of claim 11, wherein activating the one or more selectively activatable payload connectors provided in the payload support member includes activating one or more electromagnets provided in the payload support surface.
